(19) United States
(12) Patent Application Publication
(10) Pub. No.: US 2018/0034781 A1
(43) Pub. Date: Feb. 1, 2018

(54) SECURITY MECHANISM FOR HYBRID NETWORKS

(71) Applicant: NOKIA SOLUTIONS AND NETWORKS OY, Espoo (FI)

(72) Inventors: Bernd JAEGER, Munich (DE); Stephane MAHIEU, Munich (DE); Volker MENDISCH, Eichenau (DE); Jing PING, Chengdu (CN)

(21) Appl. No.: 15/550,530

(22) PCT Filed: Feb. 13, 2015
(86) PCT No.: PCT/EP2015/053054

§ 371 Date: Aug. 11, 2017

(51) Int. Cl. H04L 29/06; G06F 9/455

(52) U.S. Cl. CPC H04L 63/0263; H04L 63/20; G06F 9/45558; G06F 2009/45587; G06F 2009/45595

(57) ABSTRACT

An apparatus comprising at least one processing circuitry, and at least one memory for storing instructions to be executed by the processing circuitry, wherein the at least one memory and the instructions are configured to, with the at least one processing circuitry, cause the apparatus at least: to execute management tasks in an automated manner related to a control of security in a communication between two end points of a communication connection in a hybrid communication network, wherein the security is controlled for physical and virtual parts of the hybrid communication network, and to automatically control at least one of deployment, configuration and management of a security service including at least one security function instantiated or implemented in the hybrid communication network.

### BACKGROUND

### Field

The present invention relates to apparatuses, methods, systems, computer programs, computer program products and computer-readable media usable for providing security in a hybrid communication network including physical and virtual network parts.

### Background Art

The following description of background art may include insights, discoveries, understandings or disclosures, or associations, together with disclosures not known to the relevant prior art, to at least some examples of embodiments of the present invention but provided by the invention. Some of such contributions of the invention may be specifically pointed out below, whereas other of such contributions of the invention will be apparent from the related context.

The following meanings for the abbreviations used in this specification apply:

3GPP 3^{rd} Generation Partner Project

ACK: acknowledgment

AP: access point

API: application programming interface

BS: base station

BSS: business support system

DMZ: demilitarized zone

DSL: digital subscriber line

E2E: endpoint-to-endpoint

EM: element manager

eNB: evolved node B

ETSI European Telecommunications Standards Institute

ID: identification, identifier

IMS: IP multimedia system

IP Internet protocol

KPI: key performance indicator

LTE: Long Term Evolution

LTE-A: LTE Advanced

M2M: machine to machine

NE: network element

NF: network function

NFV: network function virtualization

NVFI: NVF infrastructure

NFVO: NFV orchestrator

NS: network service

NSD: network service descriptor

NSR: network service record

OS: operation system

OSS: operation support system

PNF: physical network function

PSF: physical security function

PSFR: physical security function record

SB: security baseline

SBD: security baseline descriptor

SBR: security baseline record

SDN software defined networks/networking

SEM: security element manager

SFD: security function descriptor

SFR: security function record

SO: security orchestrator

SP: security policy

SPD: security policy/procedure descriptor

SPR: security policy/procedure record

SR: security rule

SRD: security rule descriptor

SRR: security rule record

SS: security service

SSD: security service descriptor

SSR: security service record

ST: service tool

SW: software

UE: user equipment

UMTS: universal mobile telecommunication system

VIM: virtual infrastructure manager

VM: virtual machine

VNF: virtual network function

VNFC: virtual network function component

VNFM: virtual network function manager

VSF: virtual security function

VSFC: virtual security function component

VSFM: virtual security function manager

VSFR: virtual security function record

Embodiments of the present invention are related to a hybrid communication network comprising at least one virtualized network function, virtualized communication function or communication application and at least one physical network function or communication function. A virtualized network function, communication function or communication application may be of any type, such as a virtual core network function, a virtual access network function, a virtual IMS element, a virtualized terminal function, a function or element capable to an M2M communication, or the like.

### SUMMARY

According to an example of an embodiment, there is provided, for example, an apparatus comprising at least one processing circuitry, and at least one memory for storing instructions to be executed by the processing circuitry, wherein the at least one memory and the instructions are configured to, with the at least one processing circuitry, cause the apparatus at least: to execute management tasks in an automated manner related to a control of security in a communication between two end points of a communication connection in a hybrid communication network, wherein the security is controlled for physical and virtual parts of the hybrid communication network, and to automatically control at least one of deployment, configuration and management of a security service including at least one security function instantiated or implemented in the hybrid communication network.

Furthermore, according to an example of an embodiment, there is provided, for example, a method comprising executing in an automated manner management tasks related to a control of security in a communication between two end points of a communication connection in a hybrid communication network, wherein the security is controlled for physical and virtual parts of the hybrid communication network, and controlling automatically at least one of a deployment, configuration and management of a security service including at least one security function instantiated or implemented in the hybrid communication network.

Moreover, according to an example of an embodiment, there is provided, for example, a computer program product, comprising a computer usable medium having a computer readable program code embodied therein, the computer readable program code adapted to execute a process comprising executing management tasks in an automated manner related to a control of a security in a communication between two end points of a communication connection in a hybrid communication network, wherein the security is controlled for physical and virtual parts of the hybrid communication network, and controlling automatically at least one of a deployment, configuration and management of a security service including at least one security function instantiated or implemented in the hybrid communication network.

According to further refinements, these examples may include one or more of the following features:
the at least one security function may comprise at least one of a physical security function provided by a physical part of the hybrid communication network, a virtual security function provided by a virtual part of the hybrid communication network, and a security function provided by a hypervisor of the hybrid communication network;
an automatic alignment of security policies of the virtual part of the hybrid communication network to each other, security policies of the physical part of the hybrid communication network to each other, security policies related to security functions provided by a hypervisor of the hybrid communication network to each other, and security policies of each of the virtual part, the physical part and the hypervisor to each other, may be conducted by executing the management tasks;
the management tasks may comprise at least one of a security service central management task adapted to manage a security service related catalog, a security function related catalog, a lifecycle of security services and elasticity of security services, a security policy central management and automation task adapted to automatically configure and maintain security policies used in the hybrid communication network, a security baseline management task adapted to provide and establish predefined baseline rules to be set for securing the hybrid communication network, a credential management task adapted to manage credential provisioning in the hybrid communication network and for management entities or functions, a trust management task adapted to evaluate a trust level of entities of the hybrid communication network and of management entities or functions and to provide information indicating the evaluated trust level, a hypervisor security function management task adapted to manage security functions provided by a hypervisor of the hybrid communication network, and a hardening security status management task adapted to provide a patch status of entities of the hybrid communication network and to support an automated patching procedure for entities of the hybrid communication network;
information storing portions may be provided including at least one of a security policy catalog, a security service catalog, a security policy instances repository and a security service instances repository, wherein the information storing portions may be used for storing information elements to be used for executing the management tasks related to the control of the security in the hybrid communication network;
at least one interface to be used for communicating with at least one of a plurality of entities of the hybrid communication network for executing the management tasks and for controlling at least one of the deployment, configuration and management of the security service may be provided, wherein the at least one interface may comprises an interface to a management entity or function managing the virtualized part of the hybrid communication network, an interface to a management entity or function managing the physical part of the hybrid communication network, an interface to a management entity or function managing a security function in a network infrastructure for the virtual part of the hybrid communication network, an interface to a management entity or function managing a virtual network/security function, an interface to a security function instantiated in the virtual part of the hybrid communication network, an interface to a security function implemented in the physical part of the hybrid communication network, and an interface to a management entity or function acting as a security element manager for managing a security function;
the interface to the management entity or function managing the virtualized part of the hybrid communication network may be an interface to a network function virtualization orchestrator of the hybrid communication network, the interface to the management entity or function managing the physical part of the hybrid communication network may be an interface to an operation support system/business support system of the hybrid communication network, and the interface to the management entity or function managing network element or function managing the network infrastructure for the virtual part of the hybrid communication network may be an interface to a virtual infrastructure manager of the hybrid communication network;
a processing for preparing a network service descriptor including information of a topology of the hybrid communication network and including information of security functions may be conducted;
for preparing the network service descriptor, a predefined baseline for implementing security policy may be provided; alternatively or additionally, for preparing the network service descriptor, a new set of procedures for implementing security policy may be obtained, and information indicating the new set of procedures for implementing security policy may be provided;
for controlling at least one of the deployment, configuration and management of the security service, a first trigger indication for configuring of at least one security function instantiated or implemented in the hybrid communication network may be received and processed, and the at least one security function instantiated or implemented in the hybrid communication network may be configured;
for controlling at least one of the deployment, configuration and management of the security service, a second trigger indication for configuring and enforcing security on at least one security function instantiated or implemented in the hybrid communication network may be received and processed, information regarding the security function and security rules may be obtained from at least one stored descriptor, and the security on the at least one security function instantiated or implemented in the hybrid communication network may be enforced;
the first trigger indication and the second trigger indication may be received from a management entity or function managing the virtualized part of the hybrid communication network or from a service tool provided at a management entity or function managing the physical part of the hybrid communication network;
the processing may be implemented in a security orchestrator element or function managing security in the hybrid communication network.

In addition, according to embodiments, there is provided, for example, a computer program product for a computer, including software code portions for performing the steps of the above defined methods, when said product is run on the computer. The computer program product may include a computer-readable medium on which said software code portions are stored. Furthermore, the computer program product may be directly loadable into the internal memory of the computer and/or transmittable via a network by means of at least one of upload, download and push procedures.

### BRIEF DESCRIPTION OF THE DRAWINGS

Some embodiments of the present invention are described below, by way of example only, with reference to the accompanying drawings, in which:

FIG. 1 shows a diagram illustrating a general architecture of a hybrid network where some examples of embodiments are implementable;

FIG. 2 shows a diagram illustrating a reference architecture of a management and orchestration system for network function virtualization in a hybrid network according to some examples of embodiments;

FIG. 3 shows a diagram illustrating a configuration of security orchestrator information elements according to some examples of embodiments;

FIG. 4 shows a workflow diagram illustrating an a processing for preparing and implementing security according to some examples of embodiments;

FIGS. 5A and 5B show diagrams illustrating a result of security policy definition according to some examples of embodiments;

FIG. 6 shows a workflow diagram illustrating a processing for deploying network security according to some examples of embodiments;

FIG. 7 shows a workflow diagram illustrating a processing for deploying network security according to some examples of embodiments;

FIG. 8 shows a workflow diagram illustrating a processing for deploying network security according to some examples of embodiments;

FIG. 9 shows a flow chart of a processing conducted in a security orchestrator element or function according to some examples of embodiments; and

FIG. 10 shows a diagram of a network element or function acting as a security orchestrator according to some examples of embodiments.

### DESCRIPTION OF EMBODIMENTS

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) like the Universal Mobile Telecommunications System (UMTS), fourth generation (4G) communication networks or enhanced communication networks based e.g. on LTE or LTE-A, fifth generation (5G) communication networks, cellular 2nd generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the European Telecommunications Standards Institute (ETSI), the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

Generally, for properly establishing and handling a communication connection between two end points (e.g. terminal devices such as user equipments (UEs) or other communication network elements, a database, a server, host etc.), one or more network elements such as communication network control elements, for example access network elements like access points, base stations, eNBs etc., and core network elements or functions, for example control nodes, support nodes, service nodes, gateways etc., are involved, which may belong to different communication network systems.

Such communication networks comprise, for example, a large variety of proprietary hardware appliances. Launching a new network service often requires yet another appliance and finding the space and power to accommodate these boxes is becoming increasingly difficult. Moreover, hardware-based appliances rapidly reach end of life. Due to this, it has been considered to use, instead of hardware based network elements, virtually generated network functions, which is also referred to as network functions virtualization. By means of software based virtualization technology, it is possible to consolidate many network equipment types onto industry standard high volume servers, switches and storage, which could be located in data centers, network nodes and in the end user premises, for example.

It is to be noted that in a communication system both approaches may be used simultaneously and in a mixed manner, which is also referred to as a hybrid communication network (referred to hereinafter as “hybrid network”), where virtual and physical nodes, elements, functions etc. coexist and form a (dynamic) network structure. For example, a core network being employed for services comprises virtual and physical network elements or functions interacting which each other. Furthermore, also other network functions besides those of a (core) network (like EPC or IMS), such as network functions of an access network element like an eNB or BS, may be provided as virtual network functions.

NFV involves the implementation of network functions in software that can run on server hardware, such as standard or default server hardware, and that can be moved to, or instantiated/setup in, various locations in the network or cloud/datacenters as required, without the need for installation of new equipment. It is to be noted that NFV is able to support SDN by providing the infrastructure upon which the SDN software can be run. Furthermore, NFV aligns closely with the SDN objectives to use commodity servers and switches. The SDN-User Plane part may be placed outside or inside the cloud.

NFV is intended to be implemented in such a manner that network functions are instantiated and located within a so-called cloud environment, i.e. a storage and processing area shared by plural users, for example. By means of this, it is for example possible to dynamically placing elements/functions of a core network in a flexible manner into the cloud.

Dynamically placing the NF into the cloud allows also that all of the NFs or some parts or functions of the core network are dynamically withdrawn completely from the cloud (i.e. de-instantiated), while other parts (legacy or SDN based or virtualized network functions) remain in the network structure as deemed necessary.

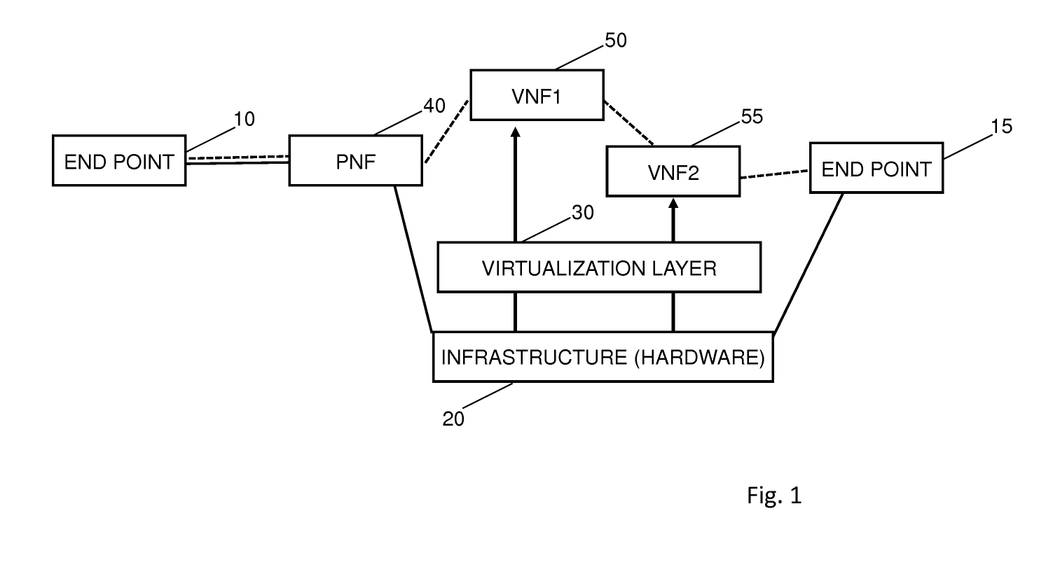

It is to be noted that instantiated (or instantiation) means in the context of the following description, for example, that a virtual network function acting in a communication network in the virtual network part (see e.g. FIG. 1) is set up, turned on, activated or made in some other manner available for other communication network elements or functions. On the other hand, de-instantiated (or de-instantiation) means, for example, that a virtual network function acting in a communication network in the virtualized network part (see e.g. FIG. 1) is turned off, deactivated or made in some other manner not available for other communication network elements or functions, i.e. the instantiation of the virtual network function in question is removed or cancelled, at least temporarily.

There are various approaches for configuring a virtualized communication network running in a cloud environment. As one example, the Management and Orchestration (MANO) working group inside the ETSI Network Function Virtualization (NFV) Industry Specification Group (ISG) has developed a telecommunication cloud concept which is also referred to as ETSI NFV Reference Architecture. There have been defined so-called management entities such as a NFV Orchestrator (NVFO), VNF Manager (VNFM) etc. which are used to deploy and manage a virtualized communication network running on a NFV infrastructure.

However, one important aspect in the field of networks and in particular communication networks is that also security services and functions have to be deployed and managed. Security concerns, for example, communication security, credential management and provisioning, trust management, hardening, etc.

In legacy networks, the management of security services and functions is possible by manual or partly-automated operation, e.g. by means of scripts.

However, in this context, not only security aspects for the virtual network part are to be considered, but since in practice network structures will be that of a hybrid network comprising both virtual and physical parts being interconnected with each other and hence, security aspects of both virtual and physical network parts as well as the interoperability therebetween have to be considered.

According to examples of embodiments of the invention, a security concept or mechanism is provided which enables, in particular for a hybrid network, a holistic end-to-end security overview and provides an automated deployment/management of security services/functions inside the hybrid network. For example, according to some examples of embodiments, a management entity is provided which is applicable to a hybrid network which may correspond, for example, to the ETSI NFV reference architecture indicated above. That is, an automated security management for a hybrid network considering security in both of the virtual and the physical parts of the hybrid network is provided. According to examples of embodiments, a security service including one or more security (physical and/or virtual) functions is deployed and/or configured and/or managed wherein security requirements for the network provided by security policies are realized by the security service and the security function(s).

Embodiments as well as principles described below are applicable in connection with any (physical or virtual) network element or function being included in a (hybrid) communication network environment, such as a terminal device, a network element, a relay node, a server, a node, a corresponding component, and/or any other element or function of a communication system or any combination of different communication systems that support required functionalities. The communication system may be any one or any combination of a fixed communication system, a wireless communication system or a communication system utilizing both fixed networks and wireless parts. The protocols used, the specifications of networks or communication systems, apparatuses, such as nodes, servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of a hybrid communication network to which the embodiments may be applied, a radio access architecture based on 3GPP standards, such as a third generation or fourth generation (like LTE or LTE-A) communication network, without restricting the embodiments to such architectures, however. It is obvious for a person skilled in the art that the embodiments may also be applied to other kinds of communication networks having suitable means by adjusting parameters and procedures appropriately, e.g. WiFi, worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), wired access, etc.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

A basic system architecture of a hybrid network including a communication system where some examples of embodiments are applicable may include an architecture of one or more communication networks including a wired or wireless access network subsystem and a core network. Such an architecture may include one or more communication network control elements, access network elements, radio access network elements, access service network gateways or base transceiver stations, such as a base station (BS), an access point (AP) or an eNB, which control a respective coverage area or cell(s) and with which one or more communication elements, user devices or terminal devices, such as a UE, or another device having a similar function, such as a modem chipset, a chip, a module etc., which can also be part of an element, function or application capable of conducting a communication, such as a UE, an element or function usable in a machine-to-machine communication architecture, or attached as a separate element to such an element, function or application capable of conducting a communication, or the like, are capable to communicate via one or more channels for transmitting several types of data. Furthermore, core network elements such as gateway network elements, policy and charging control network elements, mobility management entities, operation and maintenance elements, and the like may be included.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from an element, function or application, like a communication endpoint, a communication network control element, such as an server, a radio network controller, and other elements of the same or other communication networks besides those described in detail herein below.

A hybrid network considered in examples of embodiments may also be able to communicate with other networks, such as a public switched telephone network or the Internet. The hybrid network may also be able to support the usage of cloud services for the virtual network part thereof, wherein it is to be noted that the virtual network part of the hybrid network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage.

Furthermore, a network element, such as communication elements, like a UE, access network elements, like a radio network controller, other network elements, like a server, etc., as well as corresponding functions as described herein, and other elements, functions or applications may be implemented by software, e.g. by a computer program product for a computer, and/or by hardware. For executing their respective functions, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

With regard to FIG. 1, a diagram illustrating a general architecture of a hybrid network including a communication system is shown where some examples of embodiments are implementable. It is to be noted that the structure indicated in FIG. 1 shows only those parts and links which are useful for understanding principles underlying some examples of embodiments of the invention. As also known by those skilled in the art there may be several other network elements or devices involved e.g. in a communication between endpoints in the hybrid network which are omitted here for the sake of simplicity.

It is to be noted that examples of embodiments are not limited to the number of elements, functions, links and applications as indicated in FIG. 1, i.e. there may be implemented or instantiated more corresponding elements, functions, applications and links than those shown in FIG. 1.

Reference signs 10 and 15 denote a respective endpoint of a communication connection in the hybrid network. For example, the endpoints 10 and 15 are UEs, servers or any other network element or function between which a communication can be established.

Reference sign 40 denotes a physical network function. For example, the PNF 40 is an access node like an eNB or the like.

Reference signs 50 and 55 represent virtual network functions. For example, VNF1 50 and VNF2 55 are virtual network nodes of a core network of a communication network, such as a gateway, a management element or the like.

Reference sign 20 denotes an infrastructure for virtual network functions. For example, the infrastructure is provided by physical hardware resources comprising computing, storage and networking resources. It represents the totality of hardware and software components which build up the environment in which VNFs are deployed, managed and executed.

Reference sign 30 denotes a virtualization layer which is used to generate, on the basis of the resources provided by the infrastructure 20, virtual instances (i.e. the VNFs 50 and 55, for example). That is, the virtualization layer 30 abstracts the hardware resources and decouples the VNF from the underlying hardware.

The PNF 40, the VNF1 50 and the VNF2 55 form a so-called network service (NS). As indicated by dashes lines, logical links are established between the virtual elements of the hybrid network and between the virtual elements and the physical elements (e.g. the PNF 40 and the endpoint 15). On the other hands, physical links are established between the physical elements of the hybrid network (indicated by solid lines).

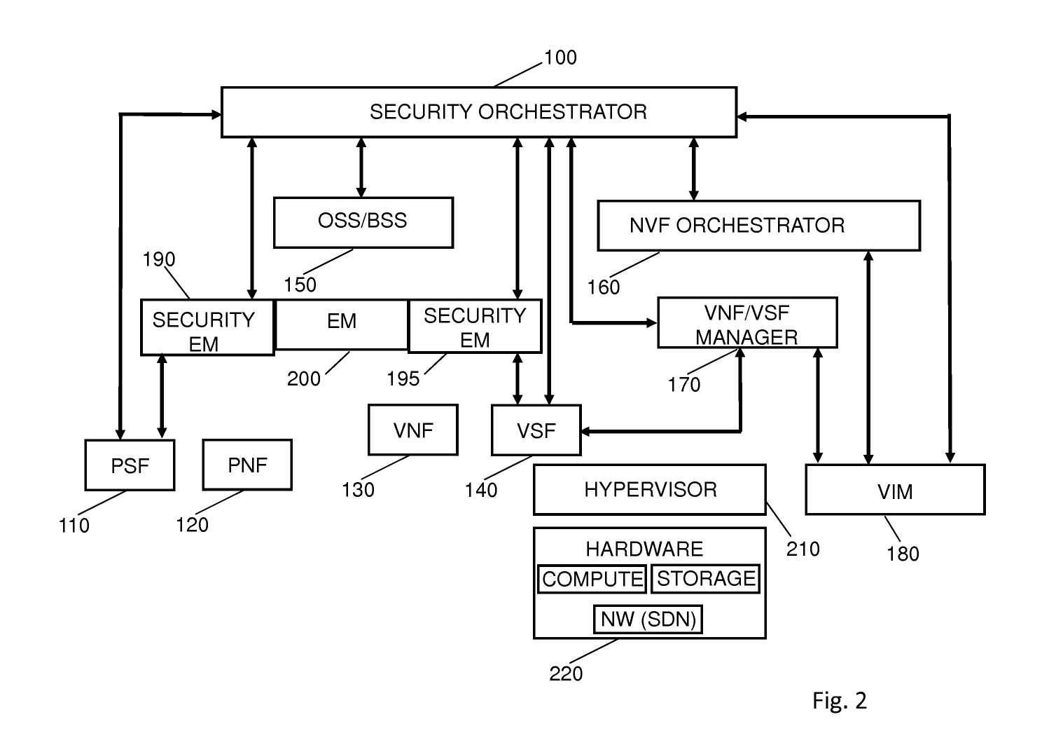

FIG. 2 shows a diagram illustrating a reference architecture of a management and orchestration system for network function virtualization in a hybrid network according to some examples of embodiments. For example, the reference architecture according to FIG. 2 is related to an ETSI NFV reference architecture as indicated above.

Reference sign 160 denotes a management entity or function like an NFV orchestrator. The NFV orchestrator 160 is used to manage the virtualized network part of the hybrid network. For example, the NFV orchestrator 160 conducts on-boarding of new network service (NS) and VNFs, wherein the NS is described by a corresponding descriptor file, orchestrated by NFVO, and wherein the NS may cover one or more VNFs and PNFs. Furthermore, NS lifecycle management (including instantiation, scaling, performance measurements, event correlation, termination) is executed. Moreover, a global resource management, validation and authorization of infrastructure resource requests and a policy management for NS instances is conducted. The NFV orchestrator 160 is responsible, for example, for NS automation and comprises a NS catalog, a VNF/VSF catalog, a NFV instances repository and a NVF resources repository for managing the virtualized network part.

Reference sign 150 denotes a management entity or element being responsible for the physical network part of the hybrid network. For example, the management entity 150 is an OSS/BSS of a network operator of the hybrid network. The OSS/BSS 150 is also responsible for triggering of the NFV orchestrator 160, for example. For example, the OSS/BSS 150 provides service tools like service fulfillment and orchestration.

Reference sign 120 denotes a physical network function (PNF), such as a “real” network element or function acting in the communication network as an instance, e.g. for access network or core network.

Reference sign 110 denotes a physical security function (PSF). For example, the PSF is an entity or element acting for securing a part of the network, such as a firewall or the like, which protects a NF (e.g. PNF 120), or a network service which may also run in the virtual part of the hybrid network.

Reference sign 200 denotes an element manager (EM) performing management functionality for network functions. Reference signs 190 and 195 denote security element managers which may be part of EM 200, a combined entity or function or separate entities or functions. The SEM 190/195 performs, for example, managing functionalities for the PSF 110, a VSF (described below), or both. It is to be noted that the PSF 110 (and/or the VSF) can be controlled either directly or via the SEM 190/195, for example.

Reference sign 170 denotes a management entity or function for managing VNF and/or VSF in the hybrid network. For example, the management entity 170 is a VNF/VSF manager being responsible for VNF/VSF lifecycle management (i.e. instantiation, update, termination) of a VNF/VSF. Also VNF/VSF elasticity management (scaling) and VNF/VSF basic configuration is conducted by the management entity 170. It is to be noted that the VNF/VSF manager 170 may also be provided for managing VNF/VSF of third parties.

Reference sign 180 denotes a management entity or function for controlling and managing interaction of a VNF/VSF with computing, storage and network resources. For example, the management entity 180 is a virtualized infrastructure manager (VIM), which controls and manages the infrastructure compute, storage and network resources within one operator's infrastructure sub-domain. The VIM 180 may also comprise management of hypervisor-based security features.

Reference sign 210 denotes a hypervisor (also referred to as virtual machine monitor) which is a piece of computer software, firmware or hardware that creates and runs virtual machines (VM), such as software based or kernel based VMs. It is to be noted that according to some examples of embodiments the hypervisor 210 may provide also security functions which will be discussed below. The hypervisor 210 is manageable via the VIM 180, for example.

The hypervisor 210 is set on hardware 220 (such as a datacenter hardware) providing compute, storage and network (SDN) resources.

Reference sign 130 denotes a virtual network function (VNF), such as a virtualized network function acting in the communication network as an instance, e.g. for access network or core network. For example, according to some examples of embodiments, a VNF may be composed of multiple VNF components (VNFCs, corresponding to VMs) where the architecture is described by a corresponding descriptor file and is instantiated by the VNF manager 170.

Reference sign 140 denotes a virtual security function (VSF). The VSF 140 is a VNF with a security functionality. A VSF may be composed of multiple VSF Components (VSFCs, corresponding to VMs). For example, the VSF is a function acting for securing a part of the hybrid network, such as a virtual firewall or the like, which protects a NF or a NS (e.g. VNF 130). The architecture of a VSF is described by a corresponding descriptor file and will be instantiated by the VNF/VSF manager 170.

Reference sign 100 denotes a management entity or function which is also referred to as security orchestrator (SO). According to examples of embodiments, the SO 100 is configured to perform security-related management tasks inside a hybrid network, wherein in the following for illustrative purposes an implementation in an ETSI NFV reference architecture is assumed. However, it is to be noted that examples of embodiments of the invention are not limited to such an implementation example.

According to some examples of embodiments, security orchestration denotes the automation of simple or complex security-related management tasks, for example in a hybrid (i.e. physical plus virtual) telecommunication network environment (in contrast to a manual or semi-automated process). That is, orchestration is to be understood as automated execution of one or more management tasks.

As indicated in FIG. 2, the SO 100 comprises a number of interfaces to other management entities inside the reference architecture. Via these interfaces, which will be described in further detail below, the SO 100 is adapted to perform interactions with the connected management entity partners for controlling at least one of deployment/configuration/management of a security service as described in the following.

According to some examples of embodiments of the invention, the SO is able to provide a holistic view on end-to-end security in hybrid networks (see e.g. FIG. 1) and to automate all security-related management tasks such as for example the control of the deployment and the configuration of all security functions in a dynamic hybrid network environment.

When referring to the architecture indicated in FIG. 2, for example, the SO 100 is from a functional point of view on the same level as the OSS/BSS 150 and the NFV orchestrator 160. While the NFV orchestrator 160 is used to manage the virtualized network, the OSS/BSS 150 is responsible for the physical network part and for triggering the NFV orchestrator 160, e.g. in case of instantiation or de-instantiation of network services realized by means of VNFs.

The SO 100, on the other hand, has a complete network view (i.e. physical plus virtualized parts) so as to control deployment of security services, realized by means of SFs, e.g. SFs provided by the hypervisor being accessible via the VIM 180, PSFs and VSFs. According to further examples of embodiments, an additional task of the SO 100 is to configure the security of NFVI resources realized by means of SDN (see also network part of hardware 220, for example). Furthermore, the SO 100 is responsible for the management and configuration of security function applications in the hybrid network in order to maintain consistent security policies for a security service realized by means of the SFs. According to examples of embodiments, management/configuration can be done directly by the SO 100 itself (i.e. by directly controlling the PSF/VSF) or alternatively via a corresponding SEM (e.g. SEM 190/195).

According to some examples of embodiments, the SO 100 is configured to automatically and consistently manage all security services, realized by means of security functions, in the hybrid network. These are one or more of the physical security functions (PSFs), such as SFs of legacy networks (e.g. PSF 110), the virtualized VSF/VM-based security functions or virtual security functions (e.g. VSF 140), and security functions provided in the hypervisor 210 (as indicated, the hypervisor-based SFs are accessible via the VIM 180, e.g. via APIs in the VIM).

It is to be noted that according to some examples of embodiments, the SO 100 configures and manages the virtual and physical security functions which are deployed by the NFVO, for example, and deploys, configures and manages security functions provided by the hypervisor 210 in the hybrid network (via VIM 180, for example).

The topology of the virtualized network, as described by means of the Network Service Descriptor (NSD), already includes the Virtual Security Functions. This complete NSD (network topology including security functions) is the result of a cooperation between the network and the security team during the preparation phase. According to the topology description in the NSD the virtualized network is built by the NFV Orchestrator (Network Orchestrator) without involvement of the Security Orchestrator. The NFV Orchestrator integrates the VSFs in the network topology without any knowledge about their security functionality (from its point of view VSFs are just as every other VNFs).

According to some examples of embodiments, the general construction or building of the VSFs is done by the VNF/VSF manager 170. In other words, a VSF can be also considered as a VNF with security functionality. However, the VNF/VSF manager 170 is not aware of this specific security functionality but builds the VSF out of its VSF components as every other VNF. According to some examples of embodiments, the VNF/VSF manager 170 conducts at least in part the configuration of VSFs, e.g. enforcement of a VSF in a specific security zone or injection of credentials to enable cryptographical protection. The information about the configuration of the VSF is already contained in the VNF/VSF descriptors (VNFD/VSFD), provided via the NSD to the VNF/VSF manager, e.g. by the NFV orchestrator 160.

According to some examples of embodiments, VSFs may be provided by third-party vendors. Therefore, the VNF/VSF manager 170 is also configured to manage virtualized third-party security applications. Alternatively, a specific third-party VSF manager can be provided which works in parallel to the VNF Manager 170 (in FIG. 2, this is not specifically indicated).

The Security Orchestrator has the end-to-end network security view and is therefore responsible to align security policies in an automated way inside of the virtualized network and also between the physical and the virtualized network. As virtualized networks are assumed to be highly flexible concerning the placement, the addresses and the number of VNFs being assigned to a specific network service, the security configuration and the security policies have to be adapted to these changing scenarios and have automatically to ensure consistent security policies. This applies for both physical and virtual security function. For example, assuming a physical security function, e.g. in front of a datacenter, like a firewall, which has rather fixed setting, those security functions are nevertheless influenced by the dynamism of the virtualized network part. For example, in case a new network service is created or an old one is removed, not only policies for virtual security functions are changed but also the policies of the physical security function have potentially to be adapted. For example, assuming a case where a network service is created comprising in a virtual part a network function being protected by two virtual firewalls as VSFs, not only the virtual firewalls have to be configured but also a physical firewall protecting, for example, a PNF located in front of the virtual part.

According to some examples of embodiments, the SO 100 executes one or more of the following management tasks (this is also referred to as orchestration, as indicated above).

As one task, a security service central management task is executed which includes also security service lifecycle and initiation of elasticity management. The security service central management is used for managing security based on a security service catalog, a security function catalog, triggering lifecycle management of the security service which includes any one or more of VSFs, PSFs and security functions in the hypervisor, monitoring the status of the security service, collecting performance KPIs of the security services, and making scaling decision based on the KPIs.

Another task is security policy central management/automation. The security policy central management is responsible to configure and maintain consistent end-to-end security policies in the hybrid network, wherein the processing related to the security policy central management is executed in an automated way.

A further task is security baseline management. Security baseline management is responsible to establish a predefined baseline for implementing security, i.e. baseline rules such as for security zoning, traffic separation, traffic protection, storage data protection, virtual security appliances, SW integrity protection, protection of management traffic, wherein in these rules common or specific regulations, standards, guidelines and best practice models for security applications, such as for telecommunication cloud security, are considered. The baseline is generated and stored in advance, for example.

Another task is credential management. For example, in a multi-tenant cloud-based environment (such as a NFV infrastructure), crypto-graphical protection is required for manifold use cases like for example traffic protection, storage data protection, SW integrity protection or protection of management traffic. Thus a central credential management in the SO 100 is provided which manages credential provisioning. Since the SO 100 controls also security in the physical network part, it is possible to provide an overall network-wide credential management. That is, according to some examples of embodiments, credential provisioning for VNFs, PNFs or other hybrid network elements or functions, as well as for entities of the management and orchestration architecture, such as management entities or functions like as NFVO, VNFM, VIM is provided by the credential management task.

A further task is trust management. According to some examples of embodiments, decisions in the hybrid network regarding interactions with other VNF or NFVI entities may depend on the degree of trust into these entities. A potential way to achieve a NFVI-wide trust management is to provide a central trust manager. The central trust manager is part of the SO 100, for example. The central trust manager is configured, for example, to evaluate a trust level (a value or parameter) indicating the trust of relevant VNF and NFVI entities and to provide a result of the evaluation (i.e. the trust level), e.g. on demand. That is, according to some examples of embodiments, trust management for VNFs, PNFs or other hybrid network elements or functions, as well as for entities of the management and orchestration architecture, such as management entities or functions like as NFVO, VNFM, VIM is provided by the trust management task.

As another task, the management of hypervisor security functions is executed. Security functions inside a virtualized network can either be provided as VSFs (a VNF with security functionality) running on top of the hypervisor 210, and/or can be provided inside the hypervisor itself (as part of the NFV infrastructure). According to some examples of embodiments, the NFV infrastructure may be operated by a legally independent NFV infrastructure provider. In this case, it is not reasonable to directly configure them by the SO 100. Therefore, the hypervisor-based security functions are accessible via the VIM 180 (as indicated above) as security features to be configured by means of APIs, for example. Security features in the context of the hypervisor security functions are for example the provisioning and the assignment of VNFs/VSFs to security zones or the provisioning of virtual firewalls. While virtual firewalls can be provided in the hypervisor as well as in form of VSFs on top of the hypervisor, according to some examples of embodiments, the provisioning and the assignment of VNFs/VSFs to security zones is conducted by means of the hypervisor as this is the only instance that controls the placement of VNFs/VSFs respectively VNFCs/VSFCs inside the NFV infrastructure.

A further task is hardening security status. Hardening security status provides the actual patch status of VNFs/VSFs including guest OS as well as of important NFV infrastructure components (for example the hypervisor). According to some examples of embodiments, also an automated patch provisioning and patching processing may be supported.

It is to be noted that the security measures described above can be summarized hereinafter (and in the claims) as a “security of communication” which is to be understood in the context of examples of embodiments of the invention in a broad sense and comprises at least one of the described security measures and/or other security measures not explicitly described herein.

As indicated above, there are several interfaces provided which allow the SO 100 to interact with other management entities (both for the physical part and the virtual part of the hybrid network) in the reference architecture for performing the holistic security orchestrator tasks. In the following, these interfaces are described in further detail.

As indicated in FIG. 2, there are interfaces (indicated by arrows) towards the PSF 110, the VSF 140 or towards SEM 190/195 managing a PSF and/or a VSFs. That is, the PSFs/VSFs can be either managed by the SO 100 directly or indirectly via a (potentially third-party) SEM. In this context, it is to be noted that according to some examples of embodiments a SEM is configured can manage both of the PSFs and VSFs for the same vendor. Multiple SEMs to manage the PSFs/VSFs of different security vendors are also possible.

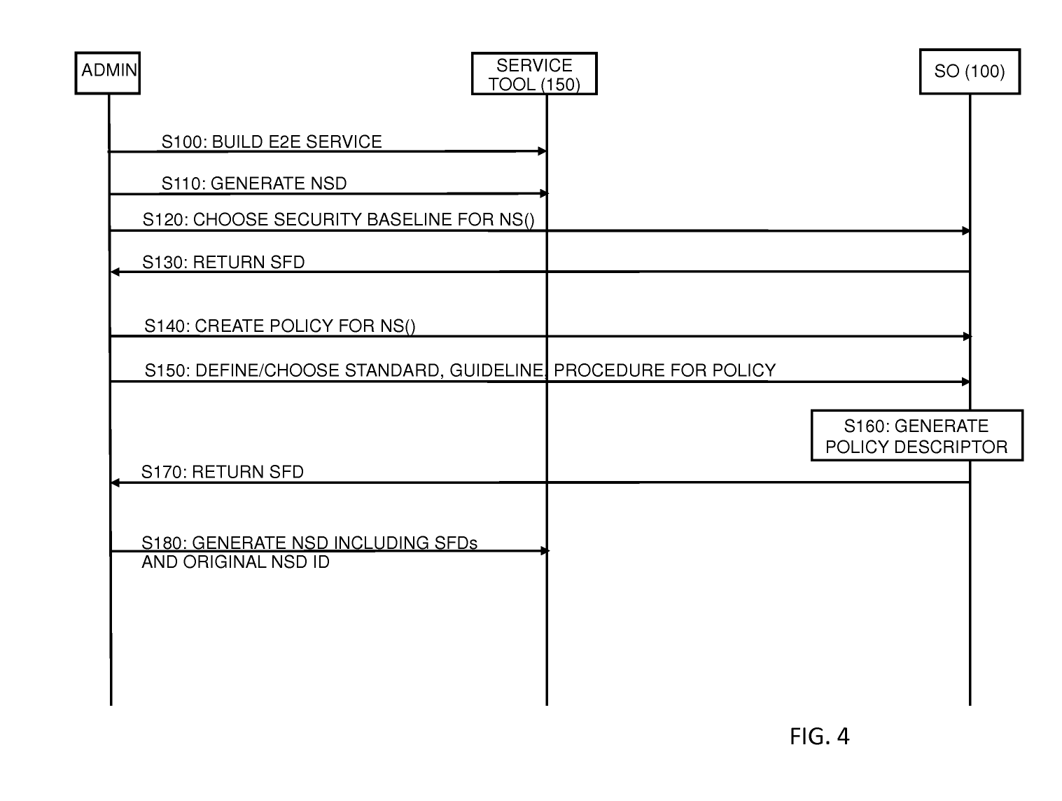

A further interface is provided towards the OSS/BSS 150 which provides e.g. service tools like service fulfillment/orchestration. This interface provides management access to the physical part of the hybrid network. For example, according to some examples of embodiments, the interface towards OSS/BSS 150 is required during a preparation phase for creating the complete NSD (including security) (see also FIG. 4). Furthermore, the interface to OSS/BSS is used in operation when the SO 100 is for example triggered by a service tool (network service orchestrator) to configure PSFs during a network deployment phase.

Another interface is the interface towards the NFV Orchestrator (NFVO) 160. This interface provides access to the virtualized part of the hybrid network. Basically, the interface towards the NFVO 160 has a similar relevance to the SO 100 as the interface towards OSS/BSS 150. For example, according to some examples of embodiments, during a deployment phase, the SO 100 is triggered by the NFV orchestrator 160 to configure the VSFs.

Another interface is the interface towards the VNF/VSF manager 170. This interface is used for procedures related to credential management and/or trust management. According to some examples of embodiments, this interface is also usable for other procedures and corresponding signaling, such as in connection with hardening and/or other management procedures.

A further interface is the interface towards the VIM 180. As described above, the VIM 180 provides a management access to security functions inside the NFV infrastructure, especially in the hypervisor 210. That is, besides the security functions running as VSFs on top of the hypervisor, the NFV infrastructure may provide also security functions like for example virtual firewalls and the establishment and enforcement of security zones. These security functions are accessible by the SO 100 by means of the interface between the SO 100 and VIM 180.

For executing the management tasks indicated above, several information elements are required by the SO 100. These information elements may be stored in or provided by storage portions as defined in the following.

In a security policy (SP) catalog, Security Policy Descriptors and Security Baseline Descriptors are stored, in addition to their reference guidelines, standards, procedures and pointers of security service descriptor.

In a security service (SS) catalog, security service descriptors, security function package (including VSFD and image, PSFD, etc.), and security rule descriptors are stored.

In a security policy (SP) instances repository, security policy records and security baseline records are stored, as well as their reference guidelines, standards, procedures and pointers of security service record. It is to be noted that an associated NS record (NSR) ID is included in the SPR/SBR.

Furthermore, a security service (SS) instances repository stores security service records, security function records (including VSFR and PSFR), and security rule records.

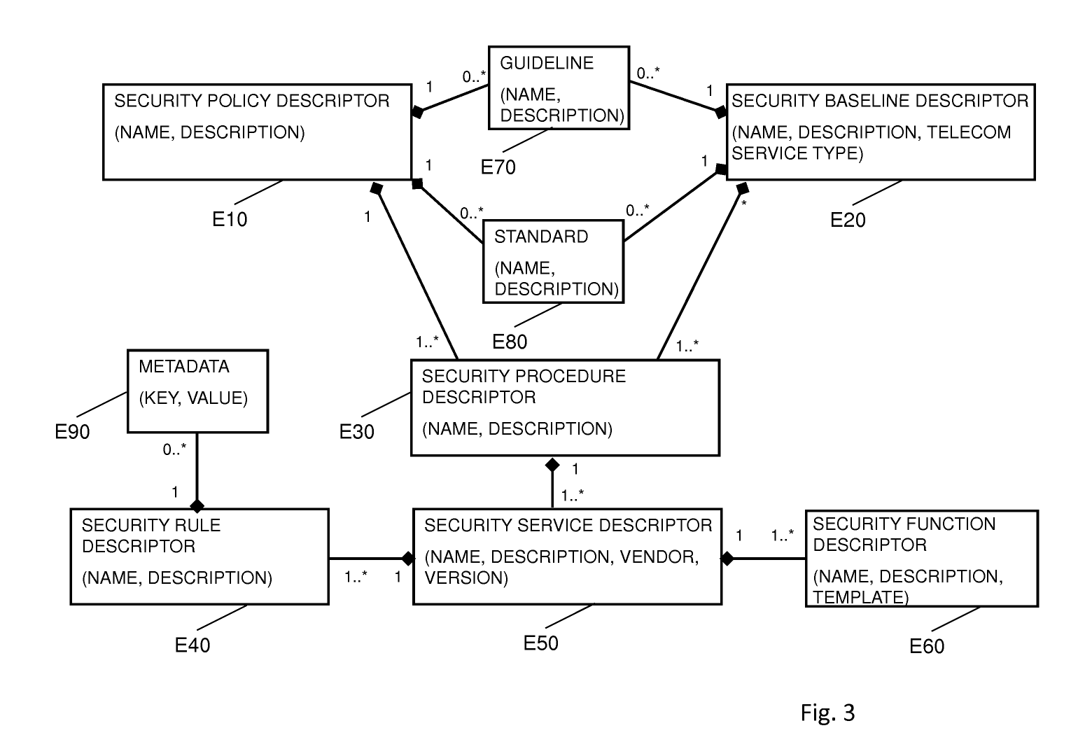

FIG. 3 shows a diagram illustrating a configuration of security orchestrator information elements according to some examples of embodiments. In detail, FIG. 3 reflects the contents and relations of information elements required for executing the management tasks as indicated above and stored in or provided by storage portions as defined above.

Specifically, FIG. 3 exemplifies these contents and relations in a structure or class diagram according to unified modeling language (UML). Here, Relationships or logical connections are illustrated by link among the objects representing the information elements. An association represents a family of links. A binary association (with two ends) is represented as a line. In FIG. 3, the information elements are linked by so-called compositions, which is a specific association type. That is, a composition is a “has a” association relationship. In FIG. 3, the graphical representation of a composition relationship is a filled diamond shape on the containing class end of a tree of lines that connect contained class(es) to the containing class.

Reference sign E10 indicates a security policy descriptor (SPD) which contains, for example, a name and a description.

Reference sign E20 indicates a security baseline descriptor (SBD) which contains, for example, a name, a description, and an indication for a telecom service type for which the baseline applies.

Reference sign E30 indicates a security procedure descriptor (SPCD) which contains, for example, a name and a description.

Reference sign E40 indicates a security rule descriptor (SRD) which contains, for example, a name and a description.

Reference sign E50 indicates a security service descriptor (SSD) which contains, for example, a name, a description, an indication of a vendor and a version number.

Reference sign E60 indicates a security function descriptor (SFD) which contains, for example, a name, a description and a template.

As indicated in FIG. 3, also other information elements are provided, such as security guidelines E70 comprising a name and a description, security standard E80 comprising a name and a description, and meta data E90 comprising e.g. a key and a value.

The respective information elements are linked to each other as indicated by corresponding associations (compositions) in FIG. 3.

As indicated above, the interactions between the SO 100 and the connected management entities as shown in FIG. 2 are related to the automated deployment and configuration of a security service including at least one of PSF(s) and VSF(s). In FIG. 4, one type of interaction according to some examples of embodiments is described. Specifically, FIG. 4 shows a workflow diagram illustrating a processing for preparing and implementing security according to some examples of embodiments.

As indicated in FIG. 4, there are two options for preparing an overall NSD including the whole network topology with security functions; it is to be noted that according to some further examples of embodiments also security function descriptors and their related security policies are provided in connection with security function related information. In these two options, one refers to a selection of a baseline for implementing security policy, while the other option refers to the creation of a new set of procedures for implementing security policy.

That is, in the examples of embodiments according to FIG. 4, the definition of security policy and its implementation for the network service is described, wherein it is assumed that a network administrator and a security administrator interact with the SO 100 and a service tool (provided e.g. by the OSS/BSS 150, e.g. Service Fulfillment, Network Engineering, or Service Orchestrator) to build a security template for the network service.

Specifically, as indicated in FIG. 4, in S100 and S110, the network administrator generates a NSD for a E2E service in cooperation with the service tool. Assuming now that the network administrator and the security administrator discuss which type of security policy is to be chosen for the network service. For example, in case the security baseline is chosen, in S120, the SO 100 is informed accordingly. As a response, in S130, the SFD according to the baseline is sent to the administrator side.

On the other hand, in case it is chosen to create new security policy for the network service, in S140, an indication is sent to the SO 100 to create a policy for the network service. Furthermore, in S150, it is signaled to the SO 100 which standard, guideline and procedure for the policy are to be defined or chosen.

In S160, the SO 100 generates or obtains a corresponding policy descriptor (for example from a predefined information being stored in advance). For example, the SPD refers to standard, guideline and procedure for its implementation (see also FIG. 3). The security service and related configuration rules are included in the policy as well.

In S170, a corresponding SFD is returned to the administrator side. That is, information about a reference VSF is returned.

It is to be noted that the above described alternatives (baseline and new policy) can be either chosen separately or in a combined manner, i.e. both can be considered for selection.

When the SFD is received, the network administrator generates in S180 a new NSD which includes the SFDs of the SS and the original NSD ID.

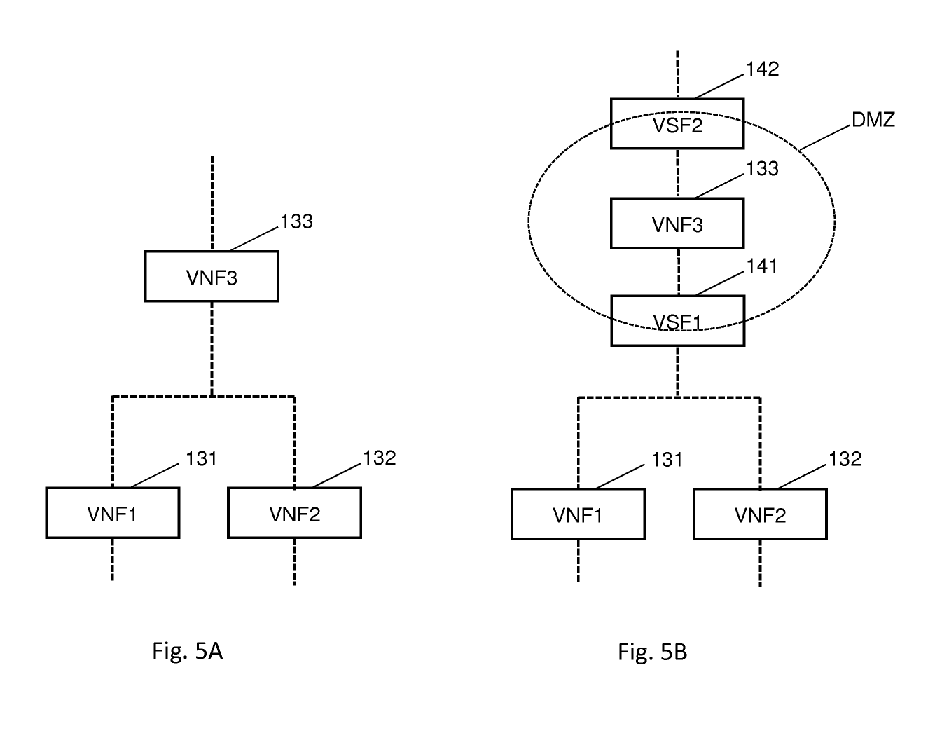

FIGS. 5A/B show diagrams illustrating a result of security policy definition according to some examples of embodiments. Specifically, FIGS. 5A/B illustrate results of a security policy definition according to the processing indicated in FIG. 4, for example.

FIG. 5A illustrates, for example, a part of a network configuration according to a starting point, i.e. before the security policy is defined. The topology in FIG. 5A is formed by three VNFs, i.e. VNF1 131, VNF2 132, VNF3 133, which form any part of a hybrid network. VNF1 131, VNF2 132, VNF3 133 are contained in the original NSD in S110 of FIG. 4, for example.

FIG. 5B illustrates the same part of the network configuration like FIG. 5A, but after the processing for defining the security policy. The topology in FIG. 5B is formed by the three VNFs, i.e. VNF1 131, VNF2 132, VNF3 133, and two VSFs VSF1 141 and VSF2 142 (for example firewalls). This topology formed by the three VNFs plus the two VSFs is returned in the NSD in S130 or S170 by the SO 100. Thus, for example, DMZ is formed around the VNF3 133.

It is to be noted that the SO 100 provides also the related security policies. Hence, the SO 100 makes it possible not only to enforce the security functions, but also enforce the related security policies on the network service via configuring rules on the security functions.

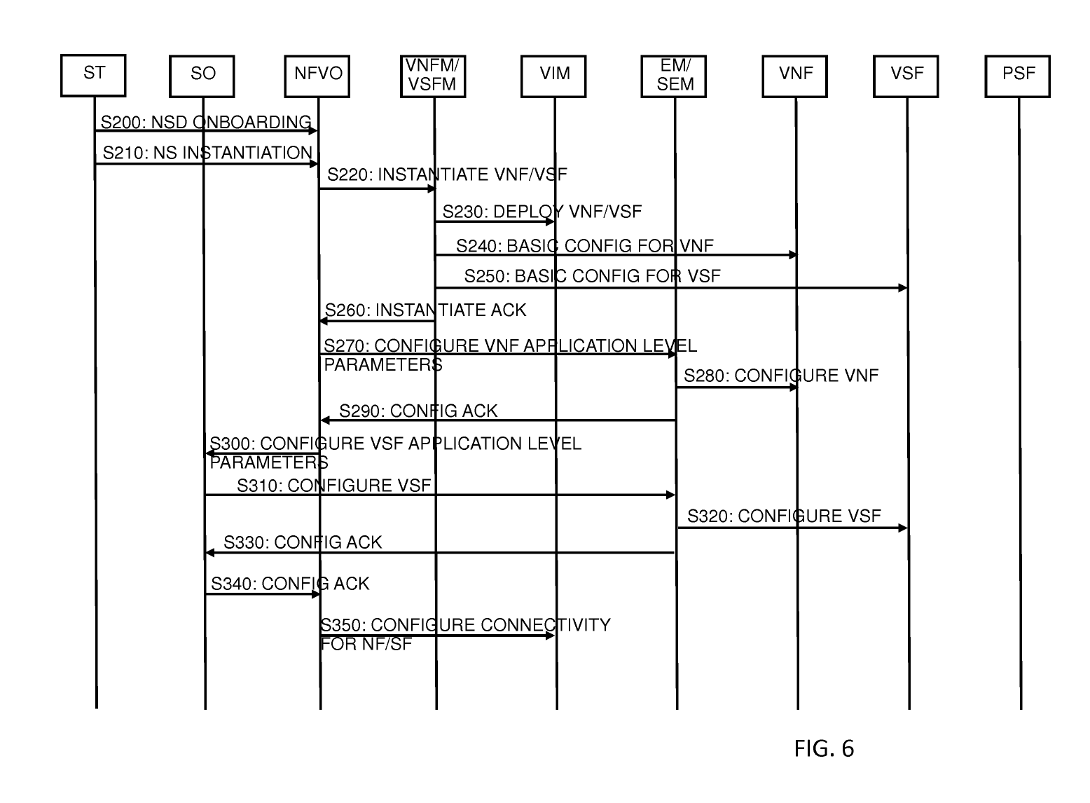

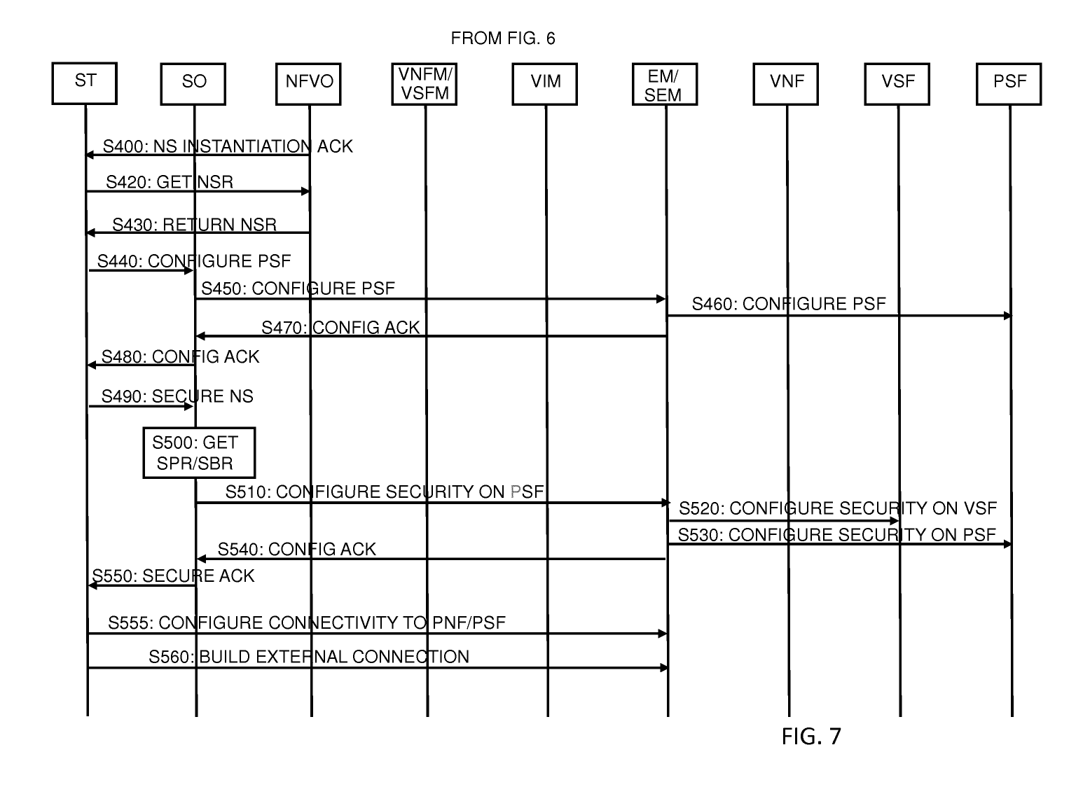

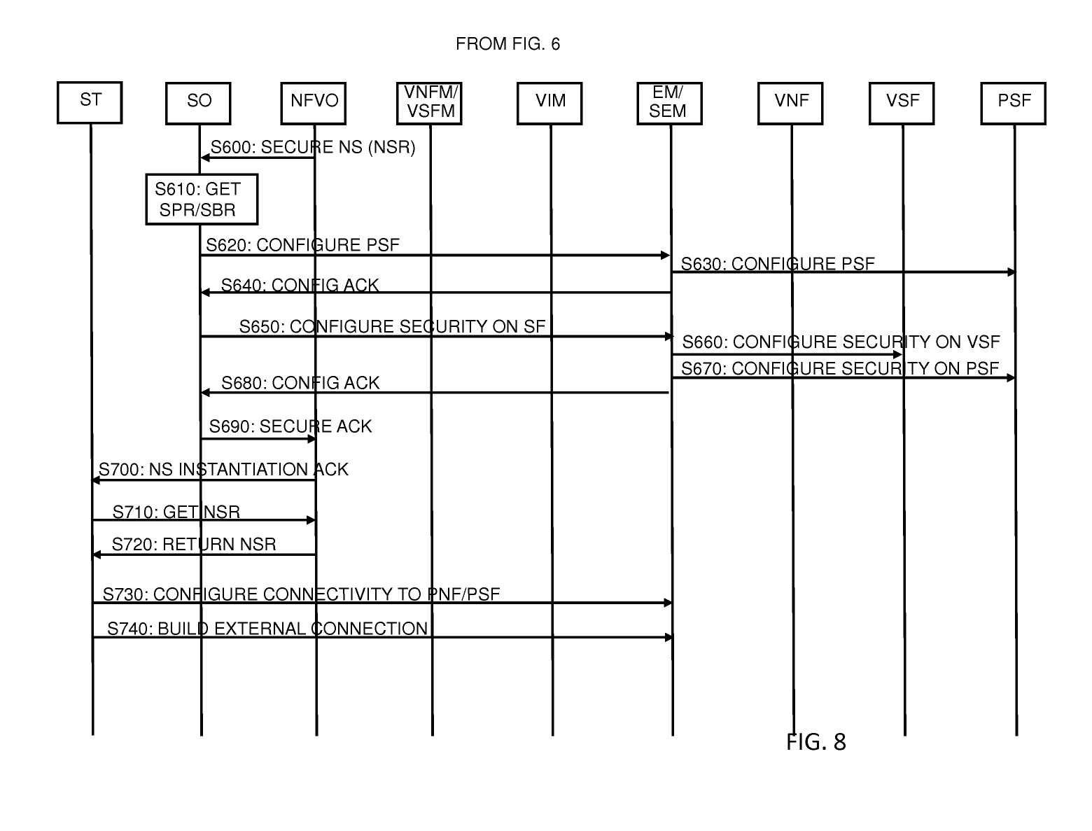

In the following, the automated deployment and configuration of PSFs and VSFs is described in connection with FIGS. 6 and 7 or FIGS. 6 and 8. Specifically, the combination of FIGS. 6 and 7 describes a first option for the automated deployment and configuration of PSFs and VSFs, while the combination of FIGS. 6 and 8 describe a second option for the automated deployment and configuration of PSFs and VSFs.

It is to be noted that for illustrative purposes the following examples are related to examples of embodiments of the invention in which the provisioning of automated E2E security for a hybrid network is integrated in ETSI NFV MANO workflows.

With regard to the workflow indicated in FIG. 6, which shows a workflow diagram illustrating a first part of a processing for deploying network security according to some examples of embodiments, it is assumed that a security policy and its implementation (and/or a security baseline) has been defined for a E2E service, wherein a NSD with security information was generated (e.g. according to examples of embodiments as indicated in FIG. 4.

First, in S200, NSD onboarding (together with VNF/VSF onboarding) is conducted between the service tool and the NVFO, and in S210, the NS instantiation is executed between the service tool and the NVFO. Thus, the service tool has triggered the instantiation of the NS by means of the NSD which includes security functions in its topology description.

Next, the NFVO and the VNFM follow defined procedures to instantiate the VNFs/VSFs and to connect them to a network service according to the NSD (without knowing about the security functionality of the VSFs), wherein the VSFs are configured via the security orchestrator. In detail, in S220, the NFVO sends to the VNFM an indication to instantiate the VNF(s) and VSF(s), as long as they are not already existent.

In S230, the VNFM informs the VIM to deploy the VNF/VSF in question. Furthermore, in S240 and S250, the VNFM conducts a basic configuration for the VNF and VSF, respectively.

After that, in S260, the VNFM acknowledges the instantiation to the NFVO.

In S270, the NFVO send a message to the EM to configure the VNF application level parameters. The EM configures the VNF accordingly in S280. Then, in S290, the configuration is acknowledged to the NFVO.

In S300, the NFVO sends a message to the SO to configure the VSF application level parameters. The SO sends in S310 a corresponding configuration message to the SEM, which configures the VSF accordingly in S320 (alternatively, the SO can configure the VSF directly). Then, in S330, the configuration is acknowledged to the SO and in S340 to the NFVO.

It is to be noted that the processing according to S220 to S340 is to be executed for each VNF/VSF instantiated in the hybrid network even though FIG. 6 shows only one VNF and VSF.

In S350, the NFVO configures connectivity for both VNFs and VSFs based on the network topology description at the VIM.

Next, with regard to the workflow indicated in FIG. 7, a workflow diagram is described which illustrates a second part of a processing for deploying network security according to some examples of embodiments, wherein the above defined first option is concerned.

After S350 of FIG. 6, in S400, the NFVO acknowledges the NS instantiation to the service tool.

In S420, the service tool signals to the NFVO in order to get the NSR. The NFVO returns the NSR to the service tool in S430.

In S440, the service tool triggers the SO to configure the PSF(s). It is to be noted that although the term ‘physical security function’ conveys a rather static impression, PSFs themselves may be virtualized as well and may therefore need configuration as well.

The SO informs the SEM in S450 to configure the PSF, and the SEM conducts configuration of the PSF(s) in S460 (alternatively, the SO can configure the PSF directly).

In S470, the configuration of the PSF(s) is acknowledged by the SEM to the SO, which in turns sends in S480 an acknowledgement to the service tool.

After the NSD with security functions is thus deployed, next, according to examples of embodiments implementing the above mentioned first option, the service tool triggers the SO to secure the network service. Specifically, in S490, the service tool sends a trigger to the SO to conduct a processing for securing the NS.

In S500, the SO instantiates and gets the SPR (and/or SBR) from storage and configures security on the security service/functions. That is, the security orchestrator gets the security functions and security rules from the security policy/baseline record and continues to enforce the security on the security functions. For this purpose, the SO informs in S510 the SEM accordingly, and the SEM configures the security on the VSF in S520 and on the PSF in S530. It is to be noted that in the example according to FIG. 7, the configuration is again conducted via the EM, but as indicated above, the SO can also directly control the SFs (PSF/VSF).

In S540, the configuration is acknowledged by the EM to the SO, which in turn sends an acknowledgement to the service tool in S550.

The service tool, in S555, can now configure connectivity to the PNF(s)/PSF(s) via the EM/SEM. It is to be noted that S410 can be omitted in case all connectivities are already built in S350, for example.

In S560, the service tool builds an external connection via the EM, that is, it connects the service e.g. to the Internet after the security for the service is enforced.

Now, with regard to the workflow indicated in FIG. 8, a workflow diagram is described which illustrates a second part of a processing for deploying network security according to some examples of embodiments, wherein the above defined second option is concerned.

While the first option described in connection with FIG. 7 enables, for example, an administrator at the service tool to have generally more influence on the automatism, e.g. by interrupting the workflow after S480 and restarting it with S490 when he has verified that the envisaged security of the network service meets his expectations, the second option described with the workflow according to FIG. 8 provides a more automated flow with less involvement of the service tool.

After S350 of FIG. 6, in S600, the NFVO triggers the SO to secure the network service. Specifically, in S490, the service tool sends a trigger to the SO to conduct a processing for securing the NS wherein the signaling includes also the NSR.

In S610, the SO instantiates and gets the SPR (and/or SBR) from storage and configures security on the security service/functions. That is, the security orchestrator gets the security functions and security rules from the security policy/baseline record and continues to enforce the security on the security functions.

For this purpose, the SO informs the SEM in S620 to configure the PSF, and the SEM conducts configuration of the PSF(s) in S630 (alternatively, the SO can configure the PSF directly). In S640, the configuration of the PSF(s) is acknowledged by the SEM to the SO (comparable to S450 to S470 in FIG. 7).

Then, the SO informs in S620 the SEM to configure security on the SFs, and the SEM configures the security on the VSF in S660 and on the PSF in S670. It is to be noted that in the example according to FIG. 8, the configuration is again conducted via the SEM, but as indicated above, the SO can also directly control the SFs (PSF/VSF).

In S680, the SEM acknowledges the configuration to the SO, and in S690, the SO acknowledges to the NFVO that the security is completed.

In S700, the NFVO acknowledges the NS instantiation to the service tool.

The service tool, in S710, signals to the NFVO in order to get the NSR. The NFVO returns the NSR to the service tool in S720.

In S730, the service tool can now configure connectivity to the PNF(s)/PSF(s) via the EM/SEM. It is to be noted that according to some examples of embodiments S730 can be omitted in case all connectivities are already built in S350 of FIG. 6, for example.

In S740, the service tool builds an external connection via the EM, that is, it connects the service e.g. to the Internet after the security for the service is enforced.

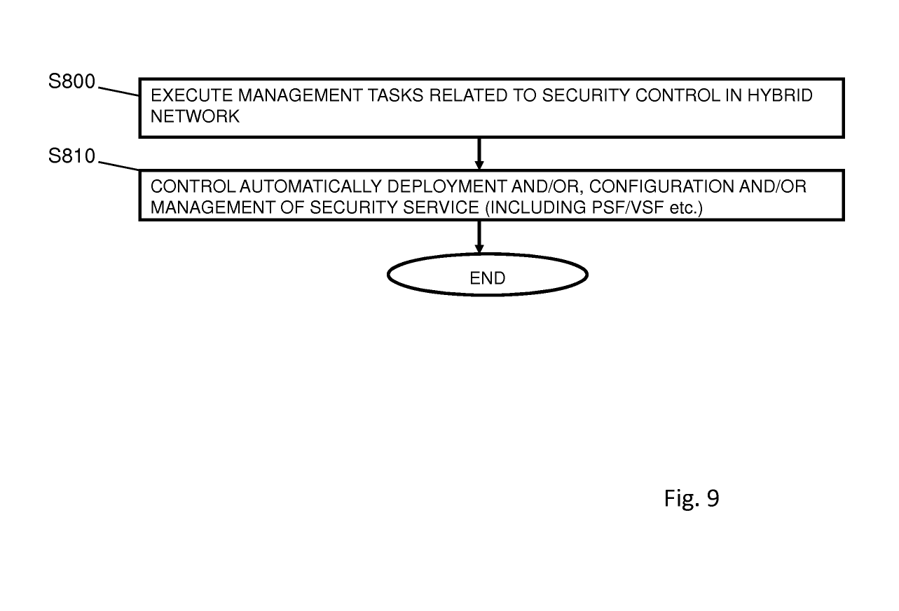

FIG. 9 shows a flow chart of a processing for managing and orchestrating security in a hybrid communication network according to some examples of embodiments. Specifically, the example according to FIG. 9 is related to a procedure conducted by a security orchestrator element or function managing security in the hybrid communication network, such as the management entity or function 100 in the architecture as depicted e.g. in FIG. 2.

In S800, management tasks related to a control of security in a communication between two end points of a communication connection in a hybrid communication network are executed in an automated manner. The security is controlled for physical and virtual parts of the hybrid communication network.

In S810, at least one of a deployment, configuration and management of a security service is controlled automatically. The security service comprises at least one security function instantiated or implemented in the hybrid communication network.

According to some examples of embodiments, such a security function comprises a physical security function (PSF, e.g. PSF 110) provided by a physical part of the hybrid communication network, and/or a virtual security function (VSF, e.g. VSF 140) provided by a virtual part of the hybrid communication network, and a security function provided by a hypervisor (e.g. hypervisor 210) of the hybrid communication network.

According to some examples of embodiments, security policies of the virtual part of the hybrid communication network, security policies of the physical part of the hybrid communication network, security policies related to security functions provided by a hypervisor of the hybrid communication network, and security policies of each of the virtual part, the physical part and the hypervisor are automatically aligned to each other by executing the management tasks.

According to some examples of embodiments, the management tasks comprises one or more of the following tasks: a security service central management task adapted to manage a security service related catalog, a security function related catalog, a lifecycle of security services and elasticity of security services, a security policy central management and automation task adapted to automatically configure and maintain security policies used in the hybrid communication network, a security baseline management task adapted to provide and establish predefined baseline rules to be set for securing the hybrid communication network, a credential management task adapted to manage credential provisioning in the hybrid communication network and for management entities or functions (e.g. NFVO, VNFM, VIM etc.), a trust management task adapted to evaluate a trust level of entities (e.g. VNFs, VSFs, PNFs, PSFs) of the hybrid communication network and management entities or functions (e.g. NFVO, VNFM, VIM etc.) and to provide information indicating the evaluated trust level, a hypervisor security function management task adapted to manage security functions provided by a hypervisor of the hybrid communication network (since according to some examples of embodiments, hypervisor security functions are accessible not directly but via the VIM 180, for example, so that a corresponding management is done via VIM 180), and a hardening security status management task adapted to provide a patch status of entities of the hybrid communication network and to support an automated patching procedure for entities of the hybrid communication network.

According to some further examples of embodiments, there are provided information storing portions (such as catalogues, repositories) which allow to store at least one of a security policy catalog, a security service catalog, a security policy instances repository and a security service instances repository. According to some further examples of embodiments, the information storing portions are used for storing information elements (such as elements indicated in FIG. 3) to be used for executing the management tasks related to the control of the security in the hybrid communication network.

Moreover, according to some further examples of embodiments, several interfaces towards management entities or functions of the hybrid communication network are provided. For example, at least one interface to be used for communicating with at least one of a plurality of entities of the hybrid communication network is provided which is used for executing the management tasks and for controlling at least one of the deployment, configuration and management of the security service. Such interfaces comprises, for example, an interface to a management entity or function managing the virtualized part of the hybrid communication network (e.g. to the NFVO 160), an interface to a management entity or function managing the physical part of the hybrid communication network (e.g. the OSS/BSS 150), an interface to a management entity or function managing a security function in a network infrastructure for the virtual part of the hybrid communication network (e.g. the VIM 180 for deploying, controlling and managing hypervisor security functions), an interface to a management entity or function managing a virtual network/security function (e.g. the VNF/VSF manager 170), an interface to a security function instantiated in the virtual part of the hybrid communication network (e.g. VSF 140), an interface to a security function implemented in the physical part of the hybrid communication network (e.g. PSF 110), and an interface to a management entity or function acting as a security element manager for managing a security function (e.g. to security EM 190/195). That is, according to some further examples of embodiments, the interface to the management entity or function managing the virtualized part of the hybrid communication network is an interface to a network function virtualization orchestrator of the hybrid communication network, the interface to the management entity or function managing the physical part of the hybrid communication network is an interface to an operation support system/business support system of the hybrid communication network, and the interface to the management entity or function managing network element or function managing the network infrastructure for the virtual part of the hybrid communication network is an interface to a virtual infrastructure manager of the hybrid communication network.

According to some further examples of embodiments, a processing for preparing a NSD including information of a topology of the hybrid communication network and including information of security functions is conducted.

In this context, according to some further examples of embodiments, for preparing the NSD, a predefined baseline for implementing security policy is provided. Alternatively or additionally, the preparation of the NSD comprises to obtain a new set of procedures for implementing security policy (according to some further examples of embodiments, the set of procedures is prepared beforehand by operators), wherein then information indicating the new set of procedures for implementing security policy is provided.

According to some further examples of embodiments, in the step of controlling at least one of the deployment, configuration and management of the security service, a first trigger indication for configuring at least one security function instantiated or implemented in the hybrid communication network is received and processed. Then, a corresponding configuration of the at least one security function instantiated or implemented in the hybrid communication network is conducted.

Furthermore, according to some further examples of embodiments, in the step of controlling at least one of the deployment, configuration and management of the security service, a second trigger indication for configuring and enforcing security on at least one security function instantiated or implemented in the hybrid communication network is received and processed. After obtaining information regarding the security function and security rules from at least one stored descriptor, the security on the at least one security function instantiated or implemented in the hybrid communication network is enforced. According to some examples of embodiments, the first trigger indication and the second trigger indication is received from a management entity or function managing the virtualized part of the hybrid communication network (e.g. the NFVO 160) or from a service tool provided at a management entity or function managing the physical part of the hybrid communication network (e.g. in the OSS/BSS 150).

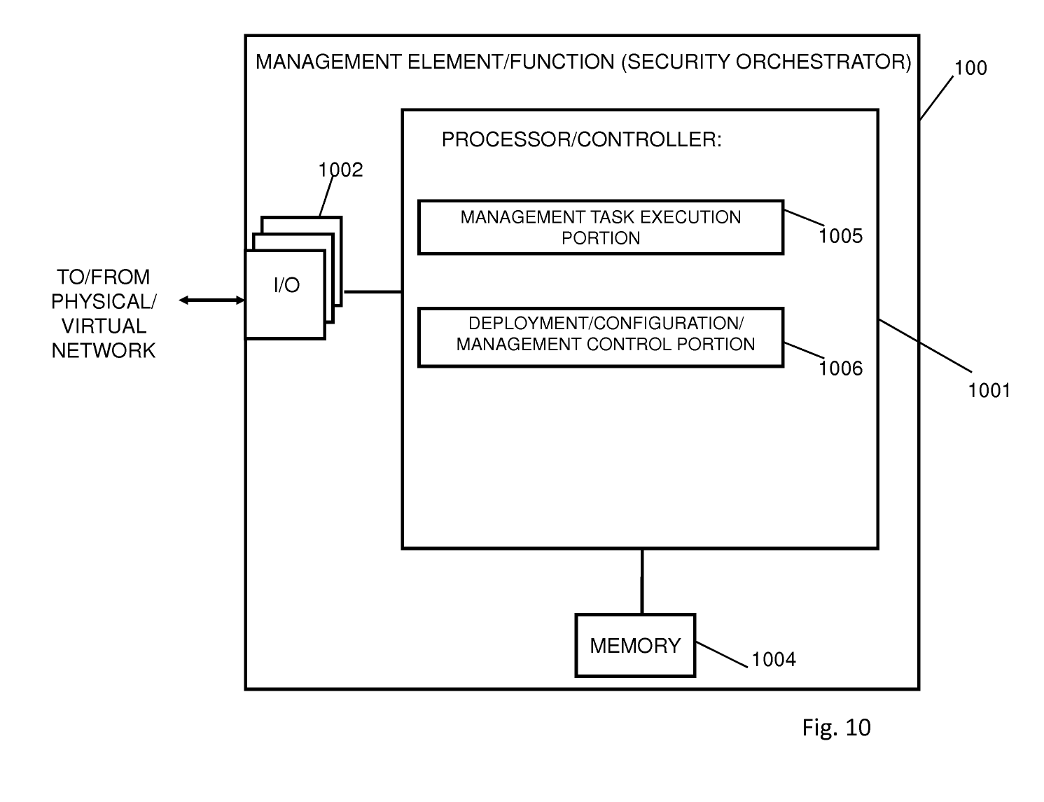

FIG. 10 shows a diagram of a network element like a managing entity serving as the SO according to some examples of embodiments, which is configured to implement a procedure for managing security in a hybrid communication network as described in connection with some of the examples of embodiments. It is to be noted that the network element, like the managing entity or function 100 of FIG. 2, which is configured to act as a SO, may include further elements or functions besides those described herein below. Furthermore, even though reference is made to a network element, management entity or function, the element, entity or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The management entity or function shown in FIG. 10 may include a processing circuitry, a processing function, a control unit or a processor 1001, such as a CPU or the like, which is suitable for executing instructions given by programs or the like related to the control procedure. The processor 1001 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference sign 1002 denotes input/output (I/O) units or functions (interfaces) connected to the processor or processing function 1001. The I/O units 1002 may be used for communicating with other management entities or functions, as described in connection with FIG. 2, for example, such as the OSS/BSS 150, the NFVO 160, the VIM 180, PSF/VSF and the like. The I/O units 1002 may be a combined unit including communication equipment towards several management entities, or may include a distributed structure with a plurality of different interfaces for different entities. Reference sign 1004 denotes a memory usable, for example, for storing data and programs to be executed by the processor or processing function 1001 and/or as a working storage of the processor or processing function 1001. It is to be noted that the memory 1004 may be implemented by using one or more memory portions of the same or different type of memory.

The processor or processing function 1001 is configured to execute processing related to the above described analysis and classification procedure. In particular, the processor or processing circuitry or function 1001 includes one or more of the following sub-portions. Sub-portion 1005 is a processing portion which is usable as a management task execution portion. The portion 1005 may be configured to perform processing according to S800 of FIG. 9. Furthermore, the processor or processing circuitry or function 1001 may include a sub-portion 1006 usable as a portion for controlling deployment, configuration and/or management. The portion 1006 may be configured to perform a processing according to S810 of FIG. 9.

As described above, according to examples of embodiments, for managing security in a hybrid communication network, a management entity or function referred to as security orchestrator is provided. For example, according to examples of embodiments, the SO is implemented as SW package structured according to the described tasks and with the defined interfaces. The SW performing the SO tasks can be implemented according to the workflow diagrams described above.

That is, according to some examples of embodiments, a mechanism is proposed allowing a holistic end-to-end security view in a hybrid communication network (e.g. in accordance with an ETSI NFV environment) and enabling an automated deployment as well as an automated configuration/management of PSFs and VSFs. Thus, a flexible and automated end-to-end security for hybrid networks implemented e.g. at least in part in a telecommunication cloud is achievable. Consequently, a flexible and automated solution for network security in telecommunication cloud solutions (e.g. in an ETSI NFV environment) can be provided. Thus, by means of the proposed automated security management of hybrid networks, which includes in particular also of the physical network part, cloud-based advantages of flexibility and automation can be maintained.

In addition, according to another example of embodiments, there is provided an apparatus comprising means for executing management tasks in an automated manner related to a control of security in a communication between two end points of a communication connection in a hybrid communication network, wherein the security is controlled for physical and virtual parts of the hybrid communication network, and means for automatically controlling at least one of deployment, configuration and management of a security service including at least one security function instantiated or implemented in the hybrid communication network.

Furthermore, according to some other examples of embodiments, the above defined apparatus may further comprise means for conducting at least one of the processing defined in the above described methods, for example a method according that described in connection with FIG. 9.

It should be appreciated that
an access technology via which traffic is transferred to and from an entity in the hybrid communication network may be any suitable present or future technology, such as WLAN (Wireless Local Access Network), WiMAX (Worldwide Interoperability for Microwave Access), LTE, LTE-A, Bluetooth, Infrared, and the like may be used; additionally, embodiments may also apply wired technologies, e.g. IP based access technologies like cable networks or fixed lines.
embodiments suitable to be implemented as software code or portions of it and being run using a processor or processing function are software code independent and can be specified using any known or future developed programming language, such as a high-level programming language, such as objective-C, C, C++, C#, Java, Python, Javascript, other scripting languages etc., or a low-level programming language, such as a machine language, or an assembler.
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, including a computer usable medium having a computer readable program code embodied therein, the computer readable program code adapted to execute a process as described in embodiments, wherein the computer usable medium may be a non-transitory medium.

Although the present invention has been described herein before with reference to particular embodiments thereof, the present invention is not limited thereto and various modifications can be made thereto.

1.-31. (canceled)

32. An apparatus comprising:
at least one processing circuitry,
and
at least one memory for storing instructions to be executed by the processing circuitry, wherein
the at least one memory and the instructions are configured to, with the at least one processing circuitry, cause the apparatus at least:
to execute management tasks in an automated manner related to a control of security in a communication between two end points of a communication connection in a hybrid communication network, wherein the security is controlled for physical and virtual parts of the hybrid communication network;
to automatically control at least one of deployment, configuration and management of a security service including at least one security function instantiated or implemented in the hybrid communication network; and
to provide at least one interface to be used for communicating with at least one of a plurality of entities of the hybrid communication network for executing the management tasks and for controlling at least one of the deployment, configuration and management of the security service, the at least one interface comprising:
an interface to a management entity or function managing the virtualized part of the hybrid communication network, being an interface to a network function virtualization orchestrator of the hybrid communication network;
an interface to a management entity or function managing the physical part of the hybrid communication network, being an interface to an operation support system/business support system of the hybrid communication network;
an interface to a management entity or function managing a security function in a network infrastructure for the virtual part of the hybrid communication network, being an interface to a virtual infrastructure manager of the hybrid communication network;
an interface to a management entity or function managing a virtual network/security function;
an interface to a security function instantiated in the virtual part of the hybrid communication network;
an interface to a security function implemented in the physical part of the hybrid communication network; and
an interface to a management entity or function acting as a security element manager for managing a security function.

33. The apparatus according to claim 32, wherein the at least one security function comprises at least one of a physical security function provided by a physical part of the hybrid communication network, a virtual security function provided by a virtual part of the hybrid communication network, and a security function provided by a hypervisor of the hybrid communication network.

34. The apparatus according to claim 32, wherein the at least one memory and the instructions are further configured to, with the at least one processing circuitry, cause the apparatus at least:
to automatically align security policies of the virtual part of the hybrid communication network to each other, security policies of the physical part of the hybrid communication network to each other, security policies related to security functions provided by a hypervisor of the hybrid communication network to each other, and security policies of each of the virtual part, the physical part and the hypervisor to each other, by executing the management tasks.

35. The apparatus according to claim 32, wherein the management tasks comprises at least one of:
a security service central management task adapted to manage a security service related catalog, a security function related catalog, a lifecycle of security services and elasticity of security services;
a security policy central management and automation task adapted to automatically configure and maintain security policies used in the hybrid communication network;
a security baseline management task adapted to provide and establish predefined baseline rules to be set for securing the hybrid communication network;
a credential management task adapted to manage credential provisioning in the hybrid communication network and for management entities or functions;
a trust management task adapted to evaluate a trust level of entities of the hybrid communication network and of management entities or functions and to provide information indicating the evaluated trust level;
a hypervisor security function management task adapted to manage security functions provided by a hypervisor of the hybrid communication network; and
a hardening security status management task adapted to provide a patch status of entities of the hybrid communication network and to support an automated patching procedure for entities of the hybrid communication network.

36. The apparatus according to claim 32, wherein the at least one memory and the instructions are further configured to, with the at least one processing circuitry, cause the apparatus at least:
to provide information storing portions including at least one of a security policy catalog, a security service catalog, a security policy instances repository and a security service instances repository, wherein the information storing portions are used for storing information elements to be used for executing the management tasks related to the control of the security in the hybrid communication network.

37. The apparatus according to claim 32, wherein the at least one memory and the instructions are further configured to, with the at least one processing circuitry, cause the apparatus at least:
to conduct a processing for preparing a network service descriptor including information of a topology of the hybrid communication network and including information of security functions;
to provide, for preparing the network service descriptor, a predefined baseline for implementing security policy;
to obtain, for preparing the network service descriptor, a new set of procedures for implementing security policy, and
to provide information indicating the new set of procedures for implementing security policy.

38. The apparatus according to claim 32, wherein the at least one memory and the instructions are further configured to, with the at least one processing circuitry, cause the apparatus at least:
for controlling at least one of the deployment, configuration and management of the security service,
to receive and process a first trigger indication for configuring at least one security function instantiated or implemented in the hybrid communication network;
to configure the at least one security function instantiated or implemented in the hybrid communication network;
to receive and process a second trigger indication for configuring and enforcing security on at least one security function instantiated or implemented in the hybrid communication network;
to obtain information regarding the security function and security rules from at least one stored descriptor; and
to enforce the security on the at least one security function instantiated or implemented in the hybrid communication network,
wherein the first trigger indication and the second trigger indication is received from a management entity or function managing the virtualized part of the hybrid communication network or from a service tool provided at a management entity or function managing the physical part of the hybrid communication network.

39. A method comprising:
executing in an automated manner management tasks related to a control of security in a communication between two end points of a communication connection in a hybrid communication network, wherein the security is controlled for physical and virtual parts of the hybrid communication network;
controlling automatically at least one of a deployment, configuration and management of a security service including at least one security function instantiated or implemented in the hybrid communication network; and
providing at least one interface to be used for communicating with at least one of a plurality of entities of the hybrid communication network for executing the management tasks and for controlling at least one of the deployment, configuration and management of the security service, wherein the at least one interface comprises:
an interface to a management entity or function managing the virtualized part of the hybrid communication network, being an interface to a network function virtualization orchestrator of the hybrid communication network;
an interface to a management entity or function managing the physical part of the hybrid communication network, being an interface to an operation support system/business support system of the hybrid communication network;
an interface to a management entity or function managing a security function in a network infrastructure for the virtual part of the hybrid communication network, being an interface to a virtual infrastructure manager of the hybrid communication network;
an interface to a management entity or function managing a virtual network/security function;
an interface to a security function instantiated in the virtual part of the hybrid communication network;
an interface to a security function implemented in the physical part of the hybrid communication network; and
an interface to a management entity or function acting as a security element manager for managing a security function.

40. The method according to claim 39, wherein the at least one security function comprises at least one of a physical security function provided by a physical part of the hybrid communication network, a virtual security function provided by a virtual part of the hybrid communication network, and a security function provided by a hypervisor of the hybrid communication network.

41. The method according to claim 39, further comprising:
aligning automatically security policies of the virtual part of the hybrid communication network to each other, security policies of the physical part of the hybrid communication network to each other, security policies related to security functions provided by a hypervisor of the hybrid communication network to each other, and security policies of each of the virtual part, the physical part and the hypervisor to each other, by executing the management tasks.

42. The method according to claim 39, wherein the management tasks comprises at least one of:
a security service central management task adapted to manage a security service related catalog, a security function related catalog, a lifecycle of security services and elasticity of security services;
a security policy central management and automation task adapted to automatically configure and maintain security policies used in the hybrid communication network;
a security baseline management task adapted to provide and establish predefined baseline rules to be set for securing the hybrid communication network;
a credential management task adapted to manage credential provisioning in the hybrid communication network and for management entities or functions;
a trust management task adapted to evaluate a trust level of entities of the hybrid communication network and of management entities or functions and to provide information indicating the evaluated trust level;
a hypervisor security function management task adapted to manage security functions provided by a hypervisor of the hybrid communication network; and
a hardening security status management task adapted to provide a patch status of entities of the hybrid communication network and to support an automated patching procedure for entities of the hybrid communication network.

43. The method according to claim 39, further comprising:
providing information storing portions including at least one of a security policy catalog, a security service catalog, a security policy instances repository and a security service instances repository, wherein the information storing portions are used for storing information elements to be used for executing the management tasks related to the control of the security in the hybrid communication network.

44. The method according to claim 39, further comprising:
conducting a processing for preparing a network service descriptor including information of a topology of the hybrid communication network and including information of security functions;
providing, for preparing the network service descriptor, a predefined baseline for implementing security policy;
obtaining, for preparing the network service descriptor, a new set of procedures for implementing security policy; and
providing information indicating the new set of procedures for implementing security policy.

45. The method according to claim 39, further comprising:
for controlling at least one of the deployment, configuration and management of the security service,
receiving and processing a first trigger indication for configuring of at least one security function instantiated or implemented in the hybrid communication network, and
configuring the at least one security function instantiated or implemented in the hybrid communication network;
receiving and processing a second trigger indication for configuring and enforcing security on at least one security function instantiated or implemented in the hybrid communication network;
obtaining information regarding the security function and security rules from at least one stored descriptor; and
enforcing the security on the at least one security function instantiated or implemented in the hybrid communication network;
wherein the first trigger indication and the second trigger indication is received from a management entity or function managing the virtualized part of the hybrid communication network or from a service tool provided at a management entity or function managing the physical part of the hybrid communication network.

46. A computer program embodied on a non-transitory computer-readable medium, including software code portions for performing the steps of claim 39 when said program is run on the computer.
